(19) United States
(12) Patent Application Publication
(10) Pub. No.: US 2009/0229057 A1
(43) Pub. Date: Sep. 17, 2009

(54) LOW SUDSING HAND WASHING LIQUID LAUNDRY DETERGENT

(76) Inventors: Jan Julian Marie-Louise BILLIAUW, Gentbrugge (BE); Wesley (Yvonne Pieter) BOERS, Antwerpen (BE); Joseph (Tan) CHIO, Beijing (CN); Ronaldo (Musico) FABICON, Beijing (CN); Biyan HUANG, Beijing (CN); Jing LI, Beijing (CN); Nixon (Lao) OCAMPOCHUA, Beijing (CN); Sylvain (Andre) SORIN, Braine I'Alleud (BE); Joia (Kirin) SPOONER-WYMAN, Cincinnati, OH (US)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/403,736

(22) Filed: Mar. 13, 2009

Related U.S. Application Data
(60) Provisional application No. 61/069,442, filed on Mar. 14, 2008.

(51) Int. Cl. C11D 17/08

(52) U.S. Cl. 8/137; 510/343

(57) ABSTRACT

A hand laundering method contains the steps of providing a liquid laundry detergent, diluting the liquid laundry detergent, hand washing laundry and rinsing the laundry. The liquid laundry detergent has a pH of from 7-13 and contains 3-40% of a sudsing surfactant, 0.01-1% of a silicone-containing suds suppressor, 25-85% water, and the balance other ingredients. The liquid laundry detergent is diluted about 1:150-1:1000 with water in a container to form a laundry liquor. Liquid laundry detergents and a method of saving water using such liquid laundry detergents are also described.

### CROSS REFERENCE TO RELATED APPLICATIONS

This application claims the benefit of U.S. Provisional Application No. 61/069,442 filed on Mar. 14, 2008.

### FIELD OF THE INVENTION

The present invention relates to liquid laundry detergents. Specifically, the present invention relates to liquid laundry detergents for hand washing.

### BACKGROUND OF THE INVENTION

Liquid laundry detergents contain sudsing surfactants for cleaning fabrics and clothing and create suds during use. Voluminous suds are especially desirable during hand washing due to heavy user involvement in the washing process and indicate the presence of enough surfactant to clean the laundry. This consumer belief is so ingrained that formulators believe that a hand wash laundry detergent which lacks ample suds during use is unacceptable. Thus hand wash detergent formulators have always sought to increase suds volume, durability and/or quality.

However, while ample suds are desirable during cleaning, it typically takes between 3-6 rinses to remove them, resulting in excessive use of rinse water per handwash household per year. As a limited resource, the water used for rinsing is then unavailable for drinking, bathing, irrigation, etc. Per local practice, rinsing may also entail an added energy or labor cost. Accordingly, it is desirable to reduce the amount of water used for rinsing.

The amount of rinsing is driven by the perception that suds in the rinse indicate that surfactant residue remains on the fabric. Therefore clothes are not believed “clean” until the suds have completely disappeared. However, it has surprisingly been found that except in cases of unusual skin sensitization and/or very concentrated washing liquors, fewer rinses can sufficiently remove surfactants and thus such extensive rinsing is not needed. Overcoming the above perception significantly reduces rinsing with little or no adverse effects.

Front-loading machine laundry detergents may contain suds suppressor emulsions at from about 0.001-0.025 wt % and liquid detergents may contain about 0.0025-0.01 wt % suds suppressor emulsion to reduce foaming during the manufacturing and filling process. Since such emulsions are typically only <25% active suds suppressor with the rest being solvents, emulsifiers, etc., the amount of active suds suppressor is much lower. These current low levels of active suds suppressor do not significantly reduce suds generation or longevity during actual use. Therefore these compositions would not provide the benefits of the present invention, even if used in the methods described herein. Thus, effective amounts of active suds suppressors have not been heretobefore actually added to hand washing liquid laundry detergents.

Accordingly, as water and other resources are becoming ever more scarce the need exists for an effective way to reduce the amount of water and/or energy used for rinsing laundry without sacrificing cleaning efficiency, effectiveness and/or the consumer's perceptions thereof.

### SUMMARY OF THE INVENTION

The present invention relates to an improved hand laundering method that contains the steps of providing a liquid laundry detergent, diluting the liquid laundry detergent, hand washing laundry and rinsing the laundry. The liquid laundry detergent has a pH of from 7-13 and contains 3-40% of a sudsing surfactant, 0.01-1% of a silicone-containing suds suppressor, 25-85% water, and the balance other ingredients. The liquid laundry detergent is diluted about 1:150-1:1000 with water in a container to form a laundry liquor.

The present invention also relates to improved liquid hand washing laundry detergents and a method of saving water using such liquid hand washing laundry detergents.

It has now been found that the invention can provide expected cleaning levels and also induce users to reduce the number of rinses so as to save water, effort, resources, etc. The invention delicately balances the cleaning power of anionic surfactants and suds suppression to reduce the need for rinsing. Since hand washing consumers typically desire voluminous suds, it is anti-intuitive to add significant suds suppressors to a hand washing laundry detergent.

Importantly, it has surprisingly been found that such a laundry detergent can be accepted because users can see past the remaining suds to watch the dirt and soils darken and foul the laundry liquor during use. The visible accumulation of dirt and soils in the laundry liquor replaces the high sudsing efficacy signal relied upon in the past. In addition, liquid laundry detergents usually are quite clear and transparent when diluted for use. This helps the user to see the darkening of the laundry liquor during use. Since granular detergents often contain insoluble zeolites, etc. which may opacify or cloud the washing liquor, the present benefits are not as apparent with a granular detergent. In addition, a liquid avoids dissolution time and effort as compared to a granular laundry detergent. Thus, the addition of a suds suppressor to a liquid handwash detergent is especially synergistic.

### DETAILED DESCRIPTION OF THE INVENTION

All temperatures herein are in degrees Celsius (° C.), and all measurements are made at 25° C. and atmospheric pressure unless otherwise indicated. All percentages, ratios, etc. herein are by weight of the final detergent unless otherwise indicated. As used herein, the term “comprising” means that other steps, ingredients, elements, etc. which do not adversely affect the end result can be added. This term encompasses the terms “consisting of” and “consisting essentially of”. Unless otherwise specifically stated, the ingredients herein are believed to be widely available from multiple suppliers and sources around the world.

As used herein, “paraffin”, includes mixtures of true paraffins and cyclic hydrocarbons.

As used herein, “silicone” encompasses a variety of relatively high molecular weight polymers containing siloxane units and hydrocarbyl group of various types like the polyorganosiloxane oils, such as polydimethyl-siloxane, dispersions or emulsions of polyorganosiloxane oils or resins, and combinations of polyorganosiloxane with silica particles wherein the polyorganosiloxane is chemisorbed or fused onto the silica.

As used herein, “suds” indicates the non-equilibrium dispersion of gas bubbles in a relatively smaller volume of a liquid such as “foam” or “lather”.

This disclosure concerns a liquid laundry detergent containing a sudsing surfactant, a silicone-containing suds suppressor, water, and the balance other detergent ingredients. A method of using such a laundry detergent is described, as is a method of saving rinse water. The invention provides benefits such as faster suds collapse, reduced suds during use, reduced need for rinsing water, reduced number of rinses, and/or water, energy and/or effort savings.

### Sudsing Surfactant:

The sudsing surfactant useful herein is typically the workhorse surfactant, removing dirt and soils from the laundry and forming voluminous, and/or resilient suds during normal use. Thus, the sudsing surfactant typically has a sudsing profile of at least about 5 cm, or from about 8 cm to 25 cm, as measured by the below Suds Testing Protocol, when the silicone-containing suds suppressor is absent. The sudsing surfactant is from about 3% to about 40%, or from about 5% to about 30%, or from about 7% to about 25% by weight of the liquid laundry detergent, and remains important as some users are reassured by some initial suds on the surface of the laundry liquor before and/or during hand washing.

In an embodiment the sudsing surfactant is an anionic surfactant well-known in detergents and has an alkyl chain length of from about 6 carbon atoms (C₆), to about 22 carbon atoms (C₂₂), or from about C₁₂ to about C₁₈. Upon physical agitation, anionic surfactants form suds at the air-water interface. Suds indicate to consumers that surfactant is present to release soils, oils, etc. Non-limiting anionic surfactants herein include:
a) linear alkyl benzene sulfonates (LAS), or C₁₁-C₁₈ LAS;
b) primary, branched-chain and random alkyl sulfates (AS), or C₁₀-C₂₀ AS;
c) secondary (2,3) alkyl sulfates having formulas (I) and (II), or C₁₀-C₁₈ secondary alkyl sulfates:

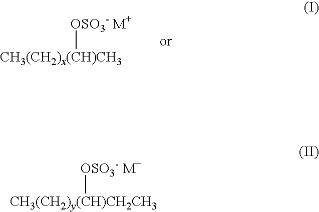

M in formulas (I) and (II) is hydrogen or a cation which provides charge neutrality such as sodium, potassium, and/or ammonium. Above, x is from about 7 to about 19, or about 9 to about 15; and y is from about 8 to about 18, or from about 9 to about 14;
d) alkyl alkoxy sulfates, and alkyl ethoxy sulfates (AEₓS), or C₁₀-C₁₈ AEₓS where x is from about 1 to about 30, or from about 2 to about 10;
e) alkyl alkoxy carboxylates, or C₆-C₁₈ alkyl alkoxy carboxylates, or those with about 1-5 ethoxy (EO) units;
f) mid-chain branched AS. See U.S. Pat. No. 6,020,303 to Cripe, et al., granted on Feb. 1, 2000; and U.S. Pat. No. 6,060,443 to Cripe, et al., granted on May 9, 2000;
g) mid-chain branched alkyl alkoxy sulfates. See U.S. Pat. No. 6,008,181 to Cripe, et al., granted on Dec. 28, 1999; and U.S. Pat. No. 6,020,303 to Cripe, et al., granted on Feb. 1, 2000;
h) methyl ester sulfonate (MES); and
i) primary, branched chain and random alkyl or alkenyl carboxylates, or those having from about 6 to about 18 carbon atoms.

In an embodiment herein, the sudsing surfactant contains a nonionic, an amphoteric, and/or a zwitterionic surfactant, often in combination with an anionic surfactant. Useful nonionic surfactants are disclosed in U.S. Pat. No. 3,929,678 to Laughlin, et al., issued Dec. 30, 1975, at col. 13, line 14-col. 16, line 6. Commercially-available nonionic surfactants useful herein include “alkyl ethoxylates” (i.e., condensation products of aliphatic alcohols with from about 1 to about 25 moles EO). The aliphatic alcohol's alkyl chain may be straight or branched, primary or secondary, and generally contains from about 8 to about 22 carbon atoms. Examples include the condensation products of C₁₀-C₂₀ alcohols with from about 2 to about 18 moles EO per mole of alcohol, such as: C₁₁-C₁₅ linear secondary alcohol with about 9 moles EO; C₁₂₋₁₄ primary alcohol with about 6 moles EO with a narrow molecular weight distribution; C₁₄₋₁₅ linear alcohol with about 9 moles EO; C₁₂₋₁₃ linear alcohol with about 6.5 moles of EO; C₁₄₋₁₅ linear alcohol with about 7 moles EO; C₁₄₋₁₅ linear alcohol with about 4 moles EO; C_{13-C15} alcohol with about 9 moles EO; C₉₋₁₁ linear alcohol with about 8 moles EO; etc. The nonionic surfactant may also be an alkyl polyglycoside, a fatty acid amide, a C₈₋₂₀ ammonia amide, monoethanolamide, diethanolamide, isopropanolamide, and a mixture thereof.

The amphoteric surfactant herein is selected from water-soluble amine oxide surfactants, including amine oxides containing one C₁₀₋₁₈ alkyl moiety and 2 moieties selected from C₁₋₃ alkyl groups and C₁₋₃ hydroxyalkyl groups; phosphine oxides containing one C₁₀₋₁₈ alkyl moiety and 2 moieties selected from C₁₋₃ alkyl groups and C₁₋₃ hydroxyalkyl groups; and sulfoxides containing one C₁₀₋₁₈ alkyl moiety and a moiety selected from C₁₋₃ alkyl and C₁₋₃ hydroxyalkyl moieties.

A useful amine oxide surfactant is:

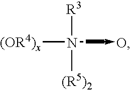

where R³ is a C₈₋₂₂ alkyl, a C₈₋₂₂ hydroxyalkyl, or a C₈₋₂₂ alkyl phenyl group; each R⁴ is a C₂₋₃ alkylene, or a C₂₋₃₂ hydroxyalkylene group; x is from 0 to about 3; and each R⁵ is a C₁₋₃ alkyl, a C₁₋₃ hydroxyalkyl, or a polyethylene oxide containing from about 1 to about 3 EOs. The R⁵ groups may form a ring structure, e.g., through an oxygen or nitrogen atom, to. The amine oxide surfactant may be a C₁₀₋₁₈ alkyl dimethyl amine oxide and/or a C₈₋₁₂ alkoxy ethyl dihydroxy ethyl amine oxide.

A useful propyl amine oxide is:

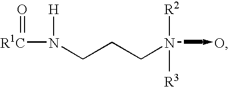

where R¹ is alkyl, 2-hydroxy C₈₋₁₈ alkyl, 3-hydroxy C₈₋₁₈ alkyl, or 3-C₈₋₁₈ alkoxy-2-hydroxypropyl; R² and R³ are each independently methyl, ethyl, propyl, isopropyl, 2-hydroxyethyl, 2-hydroxypropyl, or 3-hydroxypropyl and n is from 0 to about 10.

Also useful is:

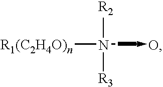

where R₁ is C₈₋₁₈ alkyl, 2-hydroxy C₈₋₁₈ alkyl, 3-hydroxy C₈₋₁₈ alkyl, or 3-C₈₋₁₈ alkoxy-2-hydroxypropyl; and R₂, R₃ are each independently methyl, ethyl, propyl, isopropyl, 2-hydroxyethyl, 2-hydroxypropyl, or 3-hydroxypropyl and n is from 0 to about 10.

Non-limiting amphoteric surfactants useful herein are known in the art and include amido propyl betaines and derivatives of aliphatic or heterocyclic secondary and ternary amines with a straight chain, or branched aliphatic moiety and wherein one of the aliphatic substituents are C₈₋₂₄ and at least one aliphatic substituent contains an anionic water-soluble group.

### Silicone-Containing Suds Suppressor

The silicone-containing suds suppressor can be any silicone-containing suds suppressor or a mixture of thereof which disrupts the surfactant at the air-water interface causing the laundry liquor's suds to collapse more easily and/or quickly, particularly in the presence of, or immediately after, agitation. Without intending to be limited by theory, we believe it is completely anti-intuitive to one skilled in the art to purposely combine a sudsing surfactant and a suds suppressor as they produce opposite effects. Also, the use of a suds suppressor in a hand wash context is completely against the previous teachings in the hand washing laundry art which emphasize the need for durable, creamy, voluminous suds. In fact, suds boosters and high sudsing surfactants have been prevalent in the hand-washing context. Especially in the context of a hand washing liquid laundry detergent, the addition of a suds suppressor is anti-intuitive as little agitation is required to dissolve and/or disperse a liquid laundry composition, as compared to for example, a granular laundry detergent. So according to previous teachings, one skilled in the art would believe that as little agitation is required for liquid detergents, even less suds is generated. So, suds boosters and high sudsing surfactants must be added to secure the level of suds which users heretobefore believe indicate effective cleaning.

Contrary to previous teachings, it is also essential in the present disclosure that the level of suds suppressor added must be based on the weight percentage of actual ingredients) having a suds-suppressing effect. So the levels herein do not otherwise include carriers, diluents, emulsifiers, etc. This is essential, as we have found that most commercially-available silicone suds suppressors are only available as either emulsions or are in a large amount of solvent—such that the actual level of active silicone-containing suds suppressor typically ranges from about 0.05% to about 40%. Based on this, in previous references, the actual level of active silicone-containing suds suppressor is greatly overstated. The level of silicone-containing suds suppressor herein is thus present at from about 0.01% to about 1%, or from about 0.01% to about 0.5% or from about 0.02% to about 0.2% of the liquid laundry detergent, when measured as the weight of active silicone-containing suds suppressor.

Without intending to be limited by theory, it is believed that a silicone suds suppressor is more effective at reducing the surface tension at the air-water interface, without adversely affecting the cleaning benefit of the sudsing surfactant at the fabric-water interface. For various silicone-containing suds suppressors, see, for example, Kirk Othmer Encyclopedia of Chemical Technology, Third Edition, Volume 7, pages 430-447 (John Wiley & Sons, Inc., 1979); U.S. Pat. No. 4,265,779, issued May 5, 1981 to Gandolfo, et al.; European Patent Application No. 89307851.9, published Feb. 7, 1990, by Starch; U.S. Pat. No. 3,455,839 to Rauner, issued Jul. 15, 1969; U.S. Pat. No. 3,933,672 to Bartolotta, et al., issued Jan. 20, 1976; and U.S. Pat. No. 4,652,392 to Baginski, et al., issued Mar. 24, 1987.

An exemplary silicone suds suppressor for use herein is a suds suppressing amount of a suds controlling agent consisting essentially of: (i) polydimethylsiloxane fluid having a viscosity of from about 20 cps. to about 1,500 cps. at 25° C.; (ii) from about 5 to about 50 parts per 100 parts by weight of (i) of siloxane resin composed of (CH₃)₃SiO½ units of SiO2 units in a ratio of from (CH₃)₃SiO½ units and to SiO2 units of from about 0.6:1 to about 1.2:1; and (iii) from about 1 to about 20 parts per 100 parts by weight of (i) of a solid silica gel. In an embodiment herein, the continuous phase solvent contains polyethylene glycols or polyethylene-polypropylene glycol copolymers or mixtures thereof; or polypropylene glycol. In an embodiment herein the silicone-containing suds suppressor is branched and/or crosslinked.

The silicone-containing suds suppressor may include (1) a nonaqueous emulsion of a primary antifoam agent which is a mixture of (a) a polyorganosiloxane, (b) a resinous siloxane or a silicone resin-producing silicone compound, (c) a finely divided filler material, and (d) a catalyst to promote the reaction of mixture components (a), (b) and (c), to form silanolates; (2) at least one nonionic silicone surfactant; and (3) polyethylene glycol or a copolymer of polyethylene-polypropylene glycol having a solubility in water at room temperature of more than about 2 weight %; and without polypropylene glycol. See also U.S. Pat. No. 4,978,471 to Starch, issued Dec. 18, 1990; U.S. Pat. No. 4,983,316 to Starch, issued Jan. 8, 1991; and U.S. Pat. No. 5,288,431 to Huber, et al., issued Feb. 22, 1994.

A useful solvent for the silicone-containing suds suppressor is polyethylene glycol having an average molecular weight of less than about 1,000, or from about 100 to about 800, or from about 200 to about 400, and a copolymer of polyethylene glycol/polypropylene glycol, or PPG 200/PEG 300. The polyethylene glycol and polyethylene/polypropylene copolymers herein have a water solubility at 20° C. of more than about 2 wt %, or more than about 5 wt %. In an embodiment herein the weight ratio of polyethylene glycol:copolymer of polyethylene-polypropylene glycol of from about 1:1 to about 1:10, or from about 1:3 to about 1:6.

A silicone-containing suds suppressor useful herein is DOW CORNING® 2-3000 ANTIFOAM, available from Dow Corning (Midland, Mich., USA), having a viscosity of about 3500 cps, and DOW CORNING® 544 ANTIFOAM, DOW CORNING® 1400 ANTIFOAM, DOW CORNING® 1410 ANTIFOAM, Silicone 3565, and other similar products available from Dow Corning. Other silicone suds suppressors useful herein include SE39 silicone gum, SE90 silicone gum, and S-339 methyl siloxane antifoaming agents which are commercially available from Wacker-Chemie GmbH (Burghausen, Germany). Examples of suitable silicone suds suppressors are the combinations of polyorganosiloxane with silica particles commercially available from Dow Corning, Wacker-Chemie and General Electric. In addition, a silicone suds suppressor may provide a thickening benefit in a high-viscosity liquid formula without adversely affecting the dissolution profile thereof.

The liquid detergent may also contain a non-silicone suds suppressor such as a paraffin antifoam, an alcohol antifoam, a fatty acid or salt thereof, a silica suds suppressor; or a monocarboxylic fatty acids and salts thereof, and/or 2-alkyl alcanol antifoam. The non-silicone suds suppressor useful herein is selected from the group consisting of a monocarboxylic fatty acid antifoam compound, a soluble monocarboxylic fatty acid salt antifoam compound, an insoluble monocarboxylic fatty acid salt, and a mixture thereof. In an embodiment herein, the non-silicone suds suppressor is a (long-chain) fatty acid as it is typically a more effective suds suppressor during the rinse cycle where there is a low total surfactant and builder concentration, and a high concentration of free hardness ions. Without intending to be limited by theory, it is believed that the combination of a silicone suds suppressor and a fatty acid will provide an improved overall experience across the entire wash process. It is also believed that the combination of silicone suds suppressor and fatty acid are synergistic as the silicone droplet particle size in the laundry liquor tends to decrease below the optimal range as the wash process evolves (especially in high agitation conditions), leading to reduced suds suppression efficacy. Here, a fatty acid may help cover for any silicone-containing suds suppressor efficiency loss. Also, a long-chain fatty acid may salt out of the laundry liquor especially at the rinse stage (forming calcium/magnesium salts) and deposit on the users' skin, improving the hand feel.

Monocarboxylic fatty acids and salts thereof are described in U.S. Pat. No. 2,954,347, issued Sep. 27, 1960 to St. John. The monocarboxylic fatty acids, and salts useful herein typically have about C₁₀₋₂₄, or about C₁₂₋₁₈ hydrocarbyl chains like tallow amphopolycarboxy glycinate. Suitable salts include the alkali metal salts such as sodium, potassium, and lithium salts, and ammonium and alkanolammonium salts. Other suitable non-silicone suds suppressors include, for example, high molecular weight hydrocarbons such as paraffin, light petroleum odorless hydrocarbons, fatty esters (e.g. fatty acid triglycerides, glyceryl derivatives, polysorbates), fatty acid esters of monovalent alcohols, aliphatic C₁₈₋₄₀ ketones (e.g. stearone) N-alkylated amino triazines such as tri- to hexa-alkylmelamines or di- to tetra alkyldiamine chlortriazines formed as products of cyanuric chloride with two or three moles of a C₁₋₂₄ primary or secondary amine, propylene oxide, bis stearic acid amide and monostearyl phosphates such as monostearyl alcohol phosphate ester and monostearyl di-alkali metal phosphates and phosphate esters, quaternary ammonium compounds, di-alkyl quaternary compounds, poly functionalised quaternary compounds, and nonionic polyhydroxyl derivatives. The liquid hydrocarbons are liquid at 20° C. and atmospheric pressure, and have a pour point of from about −40° C. to about 5° C., and boiling point of at least about 110° C., while waxy hydrocarbons may have a melting point below about 100° C. The hydrocarbons include aliphatic, alicyclic, aromatic, heterocyclic saturated and/or unsaturated C₁₂₋₇₀ hydrocarbons. See U.S. Pat. No. 4,265,779, issued May 5, 1981 to Gandolfo, et al.

Copolymers of ethylene oxide (EO) and propylene oxide (PO), particularly the mixed EO/PO C₁₀₋₁₆ fatty alcohols with from about 3 to about 30 EOs and from about 1 to about 10 POs, are also suitable. Other useful non-silicone suds suppressors include C₆₋₁₆ secondary alkyl alcohols (e.g., 2-alkyl alkanols) having a C₁₋₁₆ chain like the 2-hexyldecanol available as ISOFOL16™, 2-octyldodecanol available as ISOFOL20™, and 2-butyl octanol available as ISOFOL12™ all from Condea. Mixtures of secondary alcohols are available as ISALCHEM 123™ from Enichem, and such mixtures may also include silicone suds suppressors therein. Such mixtures typically contain alcohol:silicone at a weight ratio of from about 1:5 to about 5:1. Other non-silicone suds suppressors (see Hand Book of Food Additives, ISBN 0-566-07592-X, p804) include poloxamer, polypropyleneglycol, and/or tallow derivatives.

The non-silicone suds suppressor may be from about 0.1% to about 1%, or from about 0.15% to about 0.85%, or from about 0.2% to about 0.75% of the liquid detergent, as measured by the weight of the active non-silicone suds suppressor (i.e., excluding solvent, emulsifier, etc.).

### Water

Water is present as a carrier, to enhance dispersability, to make the composition easier to use, as a solvent for optional and/or preferred ingredients, etc. The water typically is purified, or deionized water. Water is present at from about 25% to about 85%, or from about 30% to about 80%, or from about 35% to about 75% by weight of the liquid detergent.

### Structurant

The liquid detergent composition herein may contain a structurant to provide homogeneity, enhance phase and/or temperature stability, modify rheology, modify aesthetics, etc. The structurant may also help to suspend the silicone suds suppressor droplets within an isotropic liquid. Useful structurant herein include C₁₋₃ lower alkanols such as methanol, ethanol and/or propanol, and/or C₁₋₃ lower alkanolamines such as mono-, di- and triethanolamines. If present, the active amount of structurant may be from about 0.01% to about 5%, or about 0.05% to about 2%, or from about 0.1% to about 1% by weight of the liquid laundry detergent.

Generally, the structurant contains a fatty acid, a fatty ester, a fatty soap water-insoluble wax-like substance, and mixtures thereof. Suitably hydroxyl-containing materials are described in PCT Publication WO 00/26285 A and include hydroxyl-containing ethers. Other examples of suitable hydroxyl containing materials include hydroxyalkylated polyhydric alcohol derivatives (PCT Publication WO 03/008527), aliphatic amide ethers (PCT Publication WO 03/040253), alkoxycarboxylate derivatives (PCT Publication WO 03/010222), hydroxycarboxylic esters (PCT Publication DE 19 622 214) and amidated triglycerides PCT Publication (DE 19 827 304), provided that the selected material is hydroxyl-functional.

A useful crystalline, hydroxyl-containing structuring agent is:

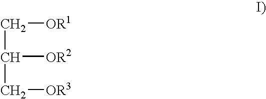

where R¹ is —C(O)R⁴, R² is R¹ or H. R³ is R¹ or H, and R⁴ is independently C₁₀₋₂₂ alkyl or alkenyl with at least one hydroxyl group; or

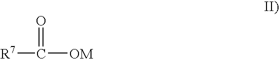

where R⁷ is C(O)R⁴, R⁴ is as defined above in i); M is Na⁺, K⁺, Mg⁺⁺ or Al⁺, or H; and iii) mixtures thereof.

Alternatively, the crystalline, hydroxyl-containing stabilizing agent may be:

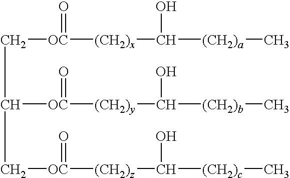

where (x+a) is from 11 to 17; (y+b) is from 11 to 17; and (z+c) is from 11 to 17; or where x=y=z=10 and/or wherein a=b=c=5. In an embodiment herein the structuring agent is selected from castor oil, a castor oil derivative; and a mixture thereof; or a hydrogenated castor oil derivative, for example, castor wax, and a mixture thereof. In an embodiment herein, the structurant contains hydrogenated castor oil plus a carrier or an emulsifier, such as available as TH1XCIN™ from Elementis.

In an embodiment herein, the ester is a triester of 12-hydroxyoctadecanonic acid, although mono and diesters can also be present. In an embodiment herein the hydroxyl-containing material does not have ethoxylated or propoxylated components or moieties.

### Other Detergent Ingredients

The detergent herein may also include optional detergent ingredients such as a detersive builder, an enzyme, an enzyme stabilizer, a soil suspending agent, a soil release agent, a buffer, a pH-adjusting agent, a chelant, a softening clay, a solvent, a hydrotrope, a phase stabilizer, a dye transfer inhibitor, a perfume, a colorant, an opacifier, an antioxidant, a bactericide, and/or a brightener. The optional detergent ingredients, if present herein, should be utilized at typical concentrations and levels such as from about 10% to about 50%, or from about 30% to about 40%, by weight. A few of these optional ingredients are described below in greater detail.

The detergent herein may contain an inorganic or organic detergent builder which counteracts the effects of calcium, or other ion, water hardness. Examples include the alkali metal citrates, succinates, malonates, carboxymethyl succinates, carboxylates, polycarboxylates and polyacetyl carboxylate; or sodium, potassium and lithium salts of oxydisuccinic acid, mellitic acid, benzene polycarboxylic acids, and citric acid; or citric acid and citrate salts. Organic phosphonate type sequestering agents such as DEQUEST™ by Monsanto and alkanehydroxy phosphonates are useful. Other organic builders include higher molecular weight polymers and copolymers, e.g., polyacrylic acid, polymaleic acid, and polyacrylic/polymaleic acid copolymers and their salts, such as SOKALAN™ by BASF. Generally, the builder may be up to 30%, or from about 1% to about 20%, or from abut 3% to about 10%.

The compositions herein may also contain from about 0.01% to about 10%, or from about 2% to about 7%, or from about 3% to about 5% of a C₈₋₂₀ fatty acid as a builder. The fatty acid can also contain from about 1 to about 10 EO units. Suitable fatty acids are saturated and/or unsaturated and can be obtained from natural sources such a plant or animal esters (e.g., palm kernel oil, palm oil, coconut oil, babassu oil, safflower oil, tall oil, tallow and fish oils, grease, and mixtures thereof), or synthetically prepared (e.g., via the oxidation of petroleum or by hydrogenation of carbon monoxide via the Fisher Tropsch process). Useful fatty acids are saturated C₁₂ fatty acid, saturated C₁₂₋₁₄ fatty acids, saturated or unsaturated C₁₂₋₁₈ fatty acids, and a mixture thereof. Examples of suitable saturated fatty acids include captic, lauric, myristic, palmitic, stearic, arachidic and behenic acid. Suitable unsaturated fatty acids include: palmitoleic, oleic, linoleic, linolenic and ricinoleic acid.

Enzymes can be included herein for a wide variety of fabric laundering purposes, including removal of protein-based, carbohydrate-based, or triglyceride-based stains, for example, and/or for fabric restoration. Examples of suitable enzymes include, but are not limited to, hemicellulases, peroxidases, proteases, cellulases, xylanases, lipases, phospholipases, esterases, cutinases, pectinases, keratinases, reductases, oxidases, phenoloxidases, lipoxygenases, ligninases, pullulanases, tannases, pentosanases, malanases, β-glucanases, arabinosidases, hyaluronidase, chondroitinase, laccase, amylases, or combinations thereof and may be of any suitable origin. The choice of enzyme(s) takes into account factors such as pH-activity, stability optima, thermostability, stability versus active detergents, chelants, builders, etc. A detersive enzyme mixture useful herein is a protease, lipase, cutinase and/or cellulase in conjunction with amylase. Sample detersive enzymes are described in U.S. Pat. No. 6,579,839.

Enzymes are normally present at up to about 5 mg, more typically from about 0.01 mg to about 3 mg by weight of active enzyme per gram of the detergent. Stated another way, the detergent herein will typically contain from about 0.001% to about 5%, or from about 0.01% to about 2%, or from about 0.05% to about 1% by weight of a commercial enzyme preparation. Protease enzymes are present at from about 0.005 to about 0.1 AU of activity per gram of detergent. Proteases useful herein include those like subtilisins from Bacillus [e.g. subtilis, lentus, licheniformis, amyloliquefaciens (BPN, BPN′), alcalophilus,] e.g. Esperase®, Alcalase®, Everlase® and Savinase® (Novozymes), BLAP and variants (Henkel). Further proteases are described in EP 130756, WO 91/06637, WO 95/10591 and WO 99/20726.

Amylases (α and/or β) are described in GB Pat. # 1 296 839, WO 94/02597 and WO 96/23873; and available as Purafect Ox Am® (Genencor), Termamyl®, Natalase®, Ban®, Fungamyl®, Duramyl® (all ex Novozymes), and RAPIDASE (International Bio-Synthetics, Inc).

The cellulase herein includes bacterial and/or fungal cellulases with a pH optimum of between 5 and 9.5. Suitable cellulases are disclosed in U.S. Pat. No. 4,435,307 to Barbesgoard, et al., issued Mar. 6, 1984. Cellulases useful herein include bacterial or fungal cellulases, e.g. produced by Humicola insolens, particularly DSM 1800, e.g. 50 kD and ˜43 kD (Carezyyme®). Also suitable cellulases are the EGIII cellulases from Trichoderma longibrachiatum. WO 02/099091 by Novozymes describes an enzyme exhibiting endo-beta-glucanase activity (EC 3.2.1.4) endogenous to Bacillus sp., DSM 12648; for use in detergent and textile applications; and an anti-redeposition endo-glucanase in WO 04/053039. Kao's EP 265 832 describes alkaline cellulase K, CMCase I and CMCase II isolated from a culture product of Bacillus sp KSM-635. Kao further describes in EP 1 350 843 (KSM S237; 1139; KSM 64; KSM N131), EP 265 832A (KSM 635, FERM BP 1485) and EP 0 271 044 A (KSM 534, FERM BP 1508; KSM 539, FERM BP 1509; KSM 577, FERM BP 1510; KSM 521, FERM BP 1507; KSM 580, FERM BP 1511; KSM 588, FERM BP 1513; KSM 597, FERM BP 1514; KSM 522, FERM BP 1512; KSM 3445, FERM BP 1506; KSM 425. FERM BP 1505) readily-mass producible and high activity alkaline cellulases/endo-glucanases for an alkaline environment. Such endo-glucanase may contain a polypeptide (or variant thereof) endogenous to one of the above Bacillus species. Other suitable cellulases are Family 44 Glycosyl Hydrolase enzymes exhibiting endo-beta-1,4-glucanase activity from Paenibacilus polyxyma (wild-type) such as XYG1006 described in WO 01/062903 or variants thereof. Carbohydrases useful herein include e.g. mannanase (see, e.g., U.S. Pat. No. 6,060,299), pectate lyase (see, e.g., WO99/27083), cyclomaltodextrin glucanotransferase (see, e.g., WO96/33267), and/or xyloglucanase (see, e.g., WO99/02663). Bleaching enzymes useful herein with enhancers include e.g. peroxidases, laccases, oxygenases, lipoxygenase (see, e.g., WO 95/26393), and/or (non-heme) haloperoxidases.

Suitable endoglucanases include: 1) An enzyme exhibiting endo-beta-1,4-glucanase activity (E.C. 3.2.1.4), with a sequence at least 90%, or at least 94%, or at least 97% or at least 99%, or 100% identity to the amino acid sequence of positions 1-773 of SEQ ID NO:2 in WO 02/099091; or a fragment thereof that has endo-beta-1,4-glucanase activity. GAP in the GCG program determines identity using a GAP creation penalty of 3.0 and GAP extension penalty of 0.1. See WO 02/099091 by Novozymes A/S on Dec. 12, 2002, e.g., Celluclean™ by Novozymes A/S. GCG refers to sequence analysis software package (Accelrys, San Diego, Calif., USA). GCG includes a program called GAP which uses the Needleman and Wunsch algorithm to find the alignment of two complete sequences that maximizes the number of matches and minimizes the number of gaps; and 2) Alkaline endoglucanase enzymes described in EP 1 350 843A published by Kao on Oct. 8, 2003 ([0011]-[0039] and examples 1-4).

Suitable lipases include those produced by Pseudomonas and Chromobacter, and LIPOLASE®, LIPOLASE ULTRA®, LIPOPRIME® and LIPEX® from Novozymes. See also Japanese Patent Application 53-20487, laid open on Feb. 24, 1978, available from Areario Pharmaceutical Co. Ltd., Nagoya, Japan, under the trade name Lipase P “Amano.” Other commercial lipases include Amano-CES, lipases ex Chromobacter viscosum, available from Toyo Jozo Co., Tagata, Japan; and Chromobacter viscosum lipases from U.S. Biochemical Corp., U.S.A. and Diosynth Co., The Netherlands, and lipases ex Pseudomonas gladioli. Also suitable are cutinases [EC 3.1.1.50] and esterases.

Enzymes useful for liquid detergent formulations, and their incorporation into such formulations, are disclosed in U.S. Pat. No. 4,261,868 to Hora, et al., issued Apr. 14, 1981. In an embodiment, the liquid composition herein is substantially free of (i.e. contains no measurable amount of) wild-type protease enzymes.

A useful enzyme stabilizer system is a calcium and/or magnesium compound, boron compounds and substituted boric acids, aromatic borate esters, peptides and peptide derivatives, polyols, low molecular weight carboxylates, relatively hydrophobic organic compounds [e.g. certain esters, diakyl glycol ethers, alcohols or alcohol alkoxylates], alkyl ether carboxylate in addition to a calcium ion source, benzamidine hypochlorite, lower aliphatic alcohols and carboxylic acids, N,N-bis(carboxymethyl) serine salts; (meth)acrylic acid-(meth)acrylic acid ester copolymer and PEG; lignin compound, polyamide oligomer, glycolic acid or its salts; poly hexa methylene bi guanide or N,N-bis-3-amino-propyl-dodecyl amine or salt; and mixtures thereof. The detergent may contain a reversible protease inhibitor e.g., peptide or protein type, or a modified subtilisin inhibitor of family VI and the plasminostrepin; leupeptin, peptide trifluoromethyl ketone, or a peptide aldehyde. Enzyme stabilizers are present from about 1 to about 30, or from about 2 to about 20, or from about 5 to about 15, or from about 8 to about 12, millimoles of stabilizer ions per liter.

The liquid detergent herein has a neat pH of from about 7 to about 13, or about 7 to about 9, or from about 7.2 to about 8.5, or from about 7.4 to about 8.2. The detergent may contain a buffer and/or a pH-adjusting agent, including inorganic and/or organic alkalinity sources and acidifying agents such as water-soluble alkali metal, and/or alkali earth metal salts of hydroxides, oxides, carbonates, bicarbonates, borates, silicates, phosphates, and/or metasilicates; or sodium hydroxide, potassium hydroxide, pyrophosphate, orthophosphate, polyphosphate, and/or phosphonate. The organic alkalinity source herein includes a primary, secondary, and/or tertiary amine. The inorganic acidifying agent herein includes HF, HCl, HBr, HI, boric acid, sulfuric acid, phosphoric acid, and/or sulphonic acid; or boric acid. The organic acidifying agent herein includes substituted and substituted, branched, linear and/or cyclic C₁₋₃₀ carboxylic acid.

Solvents (not including water) useful herein include typical low molecular weight organic carriers such as lower alcohols (e.g., primary or secondary alcohols such as C₁₋₃ lower alkanols such as methanol, ethanol, propanol, 1, 2 propanediol, and/or isopropanol), lower C₁₋₃ alkanolamines (e.g., mono-, di- and triethanolamines), glycerin, etc. Solvents are typically present at from about 0.1% to about 50%, or from about 0.5% to about 35%, or from about 1% to about 15% by weight.

The perfume herein provides aesthetic impact either during or after laundering. Perfumes are commercially available from, e.g., Givaudan, International Flavors & Fragrances, etc., and are present at from about 0.001% to about 5%, or from about 0.01% to about 3%, or from about 0.1% to about 2.5% by weight. In an embodiment, the perfume technology contains a starch-based carrier, a cyclodextrin-based carrier, a zeolite-based carrier, a polymer-based carrier, and/or a perfume microcapsule; or a starch-based carrier and/or a perfume microcapsule. Schiff-base reaction products of perfume accords are also useful herein.

In an embodiment herein, the liquid detergent contains fine mica flakes/particles therein to provide a sparkling appearance. In an embodiment herein, the liquid laundry detergent is substantially free (i.e., provide no measurable effect) of suds boosters, as they are not needed.

### Test Methods:

The Suds Coverage Test is conducted by placing a clean 12 L round, dark red plastic container (i.e., a wash basin) on a black surface in a well-lit area. At the side's midpoint, the container has a diameter to depth ratio of about 2:1. Position a digital camera pointing straight down at the container. To provide an accurate and reproducible calculation, set photo size to 1360×1024 pixels and adjust the camera so that the inside edges of the container are just visible inside the photo edge. Dilute 15 mL liquid detergent (test detergent or control, as appropriate) with 5 L water (same water as used for the Suds Testing Protocol herein) in the container to form a laundry liquor. The laundry liquor is agitated using an IKA hand blender (approximately 1000 rpm) for 2 minutes to evenly disperse the laundry detergent and simulate actual consumers usage habits. Consequently some suds are typically generated. 1 minute after agitation is stopped, take a picture (no flash) of the entire surface of the laundry liquor, including the edges of the container. Repeat twice so that a total of 3 photographs are taken in within 10 seconds.

Cell-analysis software (Cell-Size Analysis, ver. 0.1, from TECLIS/IT-Concept Company, Longessaigne, France; www.itconceptfr.com) is used to calculate the % of the laundry liquor's surface area which is covered by suds, and that which is free from suds. Set the software to measure a “large bubble” as the surface area of the inside of the basin, and to measure “smaller bubbles” as the individual bubbles floating on the surface. Average the measurements from the 3 photographs. The laundry liquor's surface area free from suds={1−[(total of smaller bubbles' surface area)/(large bubble's surface area)]}*100.

Accordingly, in an embodiment herein at least about 25%, or from about 25% to about 100%, or from about 50% to 100%, or from about 75% to about 100%, or from about 85% to about 99%, or from about 90% to about 97% of the laundry liquor's surface area is free from suds according to the Suds Coverage Test. It is believed that it is necessary for a significant portion of the laundry liquor's surface area to be free of suds to allow the user to see into the laundry liquor during use. When the user then can see the dirt and soils entering the laundry liquor during use, then this visual signal replaces the voluminous suds signal otherwise expected.

The Suds Testing Protocol employs a suds tube machine with 6 transparent acrylic cylindrical tubes (height 30 cm; inner diameter 9 cm; outer diameter 10 cm) removably set in a rigid metal frame connected to an electrical motor that rotates the tubes end-over-end about their midpoints at a fixed speed of 30 (±3) rpm. The tubes' stoppers are removable and water-tight. The scales for reading the suds level are self-adhesive strips pre-graduated in centimeters with 0-cm leveled at the liquid surface height of 300 mL water.

To clean each tube thoroughly before each use: A) Empty the tube, fill it with hot water, seal the open end with a stopper and shake the tube vigorously. Use a scrubbing brush or sponge if needed. Empty and repeat. B) If no silicone-containing suds suppressor has been tested in the tube then go to step C); when silicone-containing suds suppressor has been in the tube, add a small amount of Na₂CO₃, fill with hot water and shake vigorously to eliminate silicone-containing suds suppressor remainders. Empty tube. C) Add 1-2 ml “Dreft” or similar-concentrated dishwashing liquid to each tube. Fill tubes ¾ with hot water, seal open end with stopper, and shake vigorously. Empty tubes. D) Fill tubes ¾ with hot water, seal open end with stopper, and shake vigorously. Empty tubes and repeat. On last emptying, hold tube upside-down and view ring of liquid along inner surface of tube. Hold tube steady. The liquid ring should move uniformly down the tube without breaking. A break indicates an impurity in or on the tube surface. In case the liquid ring breaks, repeat Step D until the ring does not break.

Reagents & Solutions: water (25° C.; hardness=150 ppm of Ca²⁺:Mg²⁺ at a 4:1 molar ratio), the liquid detergent composition herein containing the silicone-containing suds suppression system (i.e., the test composition), and an identical liquid detergent composition lacking the silicone-containing suds suppression system (i.e., the control composition). In the control composition, the silicone-containing suds suppressor is replaced with deionized water.

The test is always performed with 6 replicates per composition. To minimize systematic errors, 3 of the 6 tubes are labeled for the test composition and the remaining 3 tubes are labeled for the control composition. When the test is repeated, the labels are switched.

Fill each of the 6 tubes with 300 mL water. Measure 1 mL of the detergent (either test or control, as per the labels) and add it to the appropriate tube. Repeat for each tube, insert stoppers, and insert into metal frame. Spin for 80 revolutions. Stop the rotation and wait 1 minute. Record the highest suds height in cm (not including any residue on cylinder walls). Clean the tubes per the cleaning protocol. Switch the labels on the tubes and repeat the test so as to generate 6 replicates of each composition, with each tube placed in the same position on the rigid metal frame during the first and second runs.

The compositions herein may have a Sudsing Index of less than or equal to about 50%, or from about 50% to 0%, or from about 40% to 0%, or from about 35% to 1%, or from about 30% to 3% as compared to an identical laundry liquor lacking the silicone-containing suds suppressor. The Sudsing Index of the test composition is calculated from the average suds height of the 6 replicates from the above Suds Testing Protocol: Sudsing Index=(average suds height of the test composition)/(average suds height of the control composition)*100.

The pH of the liquid laundry detergent is measured neat, i.e., without dilution.

### Method of Use:

The liquid laundry detergent herein is typically diluted for use in a hand-washing context and in hard water conditions where the water hardness is between about 10 ppm to about 600 ppm; or from about 15 ppm to about 340 ppm; or from about 17 ppm to about 300 ppm, or from about 20 ppm to about 230 ppm of hard water ions such as Ca²⁺, Mg²⁺, etc., or such as Ca²⁺ and/or Mg²⁺. The liquid laundry detergent is typically diluted by a factor of from about 1:150 to about 1:1000, or about 1:200 to about 1:500 by volume, by placing the liquid laundry detergent in a container along with wash water to form a laundry liquor. The container is typically square, rectangular, oval or round and is wider than it is deep. The container typically has dimensions such that, and is filled by the user such that the ratio of the longest direct distance across the surface of the water (surface distance; e.g., diameter for a round container) is at least as wide as the water at its deepest point (water depth). Thus, the surface distance:depth ratio is from about 1:1 to about 12:1, or from about 2:1 to about 6:1 and may hold anywhere from about 3 liters to about 20 liters. The wash water used to form the laundry liquor is typically whatever water is easily available, such as tap water, river water, well water, etc. The temperature of the wash water may range from about 2° C. to about 50° C., or from about 5° C. to about 40° C., or from 10° C. to 40° C., although higher temperatures may be used for soaking and/or pretreating.

The liquid laundry detergent and wash water may be agitated to evenly disperse the detergent. Such agitation may form suds, but due to the presence of the suds suppressor, the suds volume should be relatively small and/or the majority of the suds may quickly burst. The dirty laundry is added to the laundry liquor and optionally soaked for a period of time. Such soaking in the laundry liquor may be overnight, or for from about 1 minute to about 12 hours, or from about 5 minutes to about 6 hours, or from about 10 minutes to about 2 hours. In a variation herein, the laundry is added to the container either before or after the wash water, and then the liquid laundry detergent is added to the container, either before or after the wash water.

The method herein optionally includes a pre-treating step where the user pre-treats the laundry with the liquid laundry detergent to form pre-treated laundry. In such a pre-treating step, the liquid laundry detergent may be added directly to the laundry at anywhere from neat to full dilution to form the pre-treated laundry, which may then be optionally scrubbed, for example, with a brush, rubbed against a hard surface, or against the laundry itself before being added to the wash water and/or the laundry liquor. Where the pre-treated laundry is added to water, then the diluting step may occur as the liquid laundry detergent from the pre-treated laundry mixes with the wash water to form the laundry liquor.

The laundry is then hand-washed by the user who typically kneels next to, sits next to or leans over the container and views the container, the surface of the laundry liquor, laundry and any suds from a downward angle. As noted, the traditional (comparative) hand washing detergent generates a significant amount of suds. As such suds usually cover most, if not all of the surface of the laundry liquor, the user of a traditional composition is not able to consistently and clearly see the laundry liquor until it is poured out. Even if some suds burst, the agitation of washing/scrubbing clothes regenerates the suds. As this was traditionally viewed as desirable, previously-existing detergents were designed to ensure suds regeneration during use.

However, in the present hand-washing process, the silicone-containing suds suppressor purposely reduces the suds floating on the surface of the water so that the consumer can see the laundry liquor from the beginning of the hand-washing process. Often a significant portion of the laundry liquor's liquid surface is visible. This allows the user to see the clear, “clean” laundry liquor at the beginning and to see the soils and/or dirt leaving the fabric and entering the laundry liquor as the laundry is washed. Thus, the user directly observes the formation of a soiled laundry liquor because of the suds-free portion of the laundry liquors' surface area. The soiled laundry liquor is darker than the original laundry liquor, dirtier than the original laundry liquor, and/or contains visible soil. Such a direct observation of the change from a clean laundry liquor to a soiled laundry liquor was previously not possible, because the typical voluminous suds obstructed such a direct view. As the silicone-containing suds suppressor continues to also reduce new suds generated during the agitation inherent in the hand-washing process, the user can continuously see the transformation of the laundry liquor into a soiled laundry liquor. This convinces the user that even though there are less suds, the liquid laundry detergent is still cleaning the laundry. For heavily soiled laundry, the user may repeat, further add additional liquid laundry detergent, soak, scrub, and/or treat the laundry with specialized implements, compositions (e.g., bleach, a laundry detergent bar, etc.) as needed.

Once the laundry is hand-washed, then the laundry may be wrung out and put aside while the laundry liquor is either used for additional laundry, poured out, etc. The same container may be used for both hand-washing the laundry and rinsing the laundry. Thus, the laundry liquor may often be emptied from the container, so that rinse water (often from the same source as the wash water), may be added; or a separate rinse container or area may be used.

In cases where a rinse container is used, the laundry and rinse water are added either one after another or concurrently, and then the laundry is agitated to remove the surfactant residue. With a traditional detergents, additional “rinse-generated” suds may be generated during this agitation step; however, in the present invention reduces rinse-generated suds. The laundry may be soaked in the rinse water and then the laundry may be wrung out, and put aside. The used rinse water is typically discarded and new rinse water is prepared. This rinsing step is repeated until the user subjectively judges that the laundry is clean—which typically means “until no more suds are present on the rinse water.” It has been found that based on this, with a typical hand-washing liquid laundry detergent, the user will rinse a total of from about 3 to about 6 times. However, it has been found that suds on the rinse water is not necessarily an accurate measurement of when the surfactant is actually removed from the laundry, because visible suds may be caused by the residual laundry liquor in the container, suds physically sticking to the fabric, etc.

With the liquid laundry detergent herein, the silicone-containing suds suppressor, especially when combined with a non-silicone suds suppressor, or a fatty acid, can continuously reduce the perceived need for so many rinses. Thus, the actual number of rinses with the liquid laundry detergent herein may more correctly correspond with the actual number needed to remove an acceptable level of surfactant residue. This in turn decreases the rinsing needed and saves significant water, effort and resources In fact, it has been surprisingly found that the average number of rinses using the invention may be half, or one third of the number of rinses using a comparable product lacking the silicone-containing suds suppression system. The number of rinses when using the liquid laundry detergent herein is typically from about 1 to about 3, or from about 1 to about 2. In an embodiment herein, the user may add to one or more rinses a fabric conditioner, a fabric softener, a laundry sour, etc. as desired.

TABLE 1

| | China | | | |
|---|---|---|---|---|
| | (comp) | China | India (comp) | India |
| Average # of | 3 | 1.5 | 3 | 1.5 |
| rinses | | | | |
| L rinse | 9 L | 9 L | 12 L | 12 L |
| water/rinse | | | | |
| laundry | 5-6 times | 5-6 times | 5-6 times | 5-6 times |
| frequency/week | | | | |
| Est. total rinsing | ~7-8.4 kL | ~3.5-4.2 kL | ~9.3-11.2 kL | ~4.6-5.6 kL |
| water used/year | | | | |

Table 1 shows the rinsing habits of actual Chinese and Indian consumers with a normal high sudsing hand wash formula (comp), and with a formula according to the invention herein which measurably saves water—from about 3,500 L to about 5,600 L per year, per household.

Manufacturing processes for liquid laundry detergents may be either batch or continuous and are well-known in the art. The liquid laundry detergent herein may be a structured liquid or an unstructured liquid. In an embodiment herein, the liquid laundry detergent is a structured liquid containing a non-polymeric, crystalline, hydroxyl-containing structuring agent which can crystallize to form a “thread-like” structuring network throughout liquid matrices. The process preferably employs a low-shear mixer such as a static batch mixer and/or an impeller mixer to ensure proper formation of the structuring network throughout the final composition. See, U.S. Pat. No. 6,855,680 to Smerznak and Broeckx, granted on Feb. 15, 2005. Processes useful herein include those described in U.S. Pub. No. 2007/0044824 A1 to Capeci, et al., published on Mar. 1, 2007 and related publications.

### EXAMPLE 1

Non-limiting formulas according to the present invention, with numbers indicating weight % of the liquid laundry detergent.

| Ingredient | A | B | C | D | E | F | G |
|---|---|---|---|---|---|---|---|
| C₁₂₋₁₆AE₃₋₇S | 9 | 11 | 6 | 8 | 10 | 5 | 11 |
| C₁₁₋₁₈LAS | 2 | 2 | 5 | 4 | 12 | 10 | 6 |
| C₁₁₋₁₅EO₉ alkyl ethoxylate | — | — | 3 | — | — | 1 | 2 |
| C₁₂₋₁₆AS | — | — | — | 1 | — | 1 | 2 |
| Citric acid/sodium citrate | 3 | 3 | 8 | 2 | 3 | 3 | 1 |
| Phosphonate builder | — | — | — | 1 | — | 2 | 3 |
| Protease enzymes | 0.2 | 0.1 | 0.1 | 0.5 | 1 | 0.1 | — |
| Amylase enzymes | 0.02 | 0.02 | — | 0.1 | 0.1 | — | — |
| Enzyme stabilizers | 1 | 1 | 1 | 2 | 3 | 1 | — |
| Structurant¹ | 0.4 | 0.2 | 0.6 | 0.7 | 0.5 | 0.1 | — |
| Structurant² | 3 | 4 | — | — | 4 | — | 7 |
| S-CSS³ | 0.06⁴ | 0.02⁵ | 0.5⁶ | 0.2⁷ | 0.04⁴ | 0.2⁸ | 0.01⁵ |
| Perfumes | 0.7 | 0.5 | 0.3 | 0.5 | 1 | 0.5 | 0.6 |
| Dyes, opacifiers | 0.001 | 0.001 | 0.001 | 0.001 | Neg.⁹ | Neg.⁹ | Neg.⁹ |
| Brighteners | 0.4 | 1 | 1 | 2 | 3 | 1 | 1 |
| Water | 70 | 69 | 72 | 68 | 52 | 67 | 55 |
| Solvents, other optional | Bal. | Bal. | Bal. | Bal. | Bal. | Bal. | Bal. |
| detergent ingredients | | | | | | | |
| Suds-free area¹⁰ | >50% | ~40% | 100% | ~95% | ~50% | ~90% | ~25% |
| Rinsing¹¹ | 2 | 2 | 1 | 1 | 2 | 2 | 3 |
| Sudsing Index | ~30% | ~20% | ~0% | ~10% | ~50% | ~5% | ~40% |

¹Hydrogenated castor oil derivative.
²Fatty acid structurant
³Silicone-containing suds suppressor.
⁴SE39 silicone gum from Wacker-Chemie, GmbH.
⁵SE90 silicone gum from Wacker-Chemie, GmbH.
⁶DOW CORNING ® 2-3000 ANTIFOAM, available from Dow Corning.
⁷DOW CORNING ® 1410 ANTIFOAM, available from Dow Corning.
⁸commercial suds suppressor from General Electric.
⁹Negligible.
¹⁰Laundry liquor's surface area free from suds, per the Suds Coverage Test.
¹¹approximate number of rinses by typical user.

For comparative formulas lacking the silicone-containing suds suppressor, the laundry liquor's surface area free from suds is typically from 0% to 10%. In all cases, the number of rinses and amount of rinsing water is much less than with a comparative formula lacking the silicone-containing suds suppressor.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein including any cross referenced or related patent or application is hereby incorporated herein by reference in its entirety unless expressly excluded or otherwise limited. The citation of any document is an admission that it is prior art with respect to any invention disclosed or claimed herein or that it alone, or in combination with any other reference or references teaches suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A hand laundering method comprising the steps of:
a. providing a liquid laundry detergent comprising:
i. from about 3% to about 40% of a sudsing surfactant;
ii. from about 0.01% to about 1% of a silicone-containing suds suppressor;
iii. from about 25% to about 85% water; and
iv. the balance other detergent ingredients,
wherein the pH of the liquid laundry detergent is from about 7 to about 13;
b. diluting the liquid laundry detergent with wash water in a container to form a laundry liquor, wherein the volume ratio of liquid laundry detergent to water is from about 1:150 to about 1:1000;
c. hand washing laundry in the laundry liquor; and
d. rinsing the laundry.

2. The method according to claim 1, further comprising the step of: soaking the laundry in the laundry liquor for a period of from about 1 minute to about 12 hours.

3. The method according to claim 1, wherein the hand washing step further comprises the step of: observing the formation of a soiled laundry liquor.

4. The method according to claim 1, further comprising the step of: pre-treating the laundry with the liquid laundry detergent to form pre-treated laundry, wherein the laundry washed in step (c) comprises pre-treated laundry.

5. The method according to claim 1, wherein the liquid laundry detergent further comprises from about 0.001% to about 5% of a structurant.

6. The method according to claim 1, wherein the number of rinses is from about 1 to about 3.

7. The method according to claim 1, wherein the liquid laundry detergent is substantially free of a suds booster.

8. The method according to claim 1, wherein the liquid laundry detergent comprises a Sudsing Index of less than about 50%.

9. The method according to claim 1, wherein the sudsing surfactant comprises an anionic surfactant.

10. The method according to claim 3, wherein after the diluting step the laundry liquor comprises a laundry liquor's surface area, wherein prior to the washing step at least 25% of the of the laundry liquor's surface area is free from suds according to the Suds Coverage Test, and wherein the observing step is through the laundry liquors' surface area which is free from suds.

11. The method according to claim 4, wherein the diluting step occurs when the pre-treated laundry is added to the wash water.

12. A liquid laundry detergent comprising:
a. from about 3% to about 40% of a sudsing surfactant;
b. from about 0.01% to about 1% of a silicone-containing suds suppressor;
c. from about 25% to about 85% water; and
d. the balance other detergent ingredients,
wherein the laundry detergent is diluted to form a hand washing laundry liquor, and wherein the detergent has a pH of from about 7 to about 13.

13. The detergent according to claim 12, wherein the detergent is substantially free of insoluble materials.

14. The detergent according to claim 12, wherein when tested according to the Suds Coverage Test, at least 25% of the of the laundry liquor's surface area is free from suds.

15. The detergent according to claim 12, further comprising from about 0.001% to 5% of a structurant.

16. The detergent according to claim 12, wherein the Sudsing Index is less than or equal to about 50%.

17. A method for saving water comprising the steps of:
a. providing a liquid laundry detergent comprising:
i. from about 3% to about 40% of a sudsing surfactant;
ii. from about 0.01% to about 1% of a silicone-containing suds suppressor;
iii. from about 25% to about 85% water; and
iv. the balance other detergent ingredients,
wherein the pH of the liquid laundry detergent is from about 7 to about 13;
b. diluting the liquid laundry detergent with wash water in a container to form a laundry liquor, wherein the volume ratio of liquid laundry detergent to water is from about 1:150 to about 1:1000;
c. hand washing laundry in the laundry liquor; and
d. rinsing the laundry, wherein the number of rinses is from about 1 to about 2.
